(19) United States
(12) Patent Application Publication
(10) Pub. No.: US 2005/0204606 A1
(43) Pub. Date: Sep. 22, 2005

(54) Wind - jammer - ice fishing wind-tip-up

(76) Inventor: Nick Dana Phillips, New London, WI (US)

Correspondence Address: NICK DANA PHILLIPS, E-8767 CUT-OFF Rd., NEW LONDON, WI, 54961, US

(21) Appl. No.: 10/801,252

(22) Filed: Mar. 17, 2004

(51) Int. Cl. A01K 97/12; A01K 97/01

(52) U.S. Cl. 43/17

(57) ABSTRACT

Ice-fishing tip-ups which comprise a support structure, an upright, a flexible, steel band, a spool, a spring, a line eyelet, a cut slot in base, a plastic wind device, attaching pin, a barrel swivel tied to line and a wire flag signal device consisting of two weights, two attaching pins, and fishing line. Line is threaded through eyelet and connected to wire signal flag end with a barrel swivel tied to line. When tip-up is set for catching fish, line is pulled, visual wire flag signaling device is triggered, weights then falling forward on flag wire. Line tied to barrel swivel then drops off from wire flag. Wire flag is then tipped up in the air, line falling to ice hole off wire flag end, falling approximately two feet. When line is tightened, spool then rotates freely against slight spring tension on spool turning on a stationary pin, which holds a spool in place.

### BACKGROUND OF INVENTION

The present invention relates to an ice-fishing wind-driven tip-up, an apparatus used in ice-fishing.

Ice-fishing is a popular sport for sportsmen to engage in winter months in central and northern states. This activity can be done with fishing reels, jig poles and ice-fishing tip-ups. A hole is then prepared by drilling or chopping through the ice on a frozen lake. Fishermen then suspend a line with bait to attract game fish into biting on a line and hook. Most of these devices are called tip-ups. The angler can fish out of a wood structure or a vehicle. Problems arise from assembly or dismantling due to ice on tip-ups that are folded or collapsed. Hole freezing occurs and freezes line in. Also poor presentation to fish is a problem. Moving baits attract fish. I had these ideas before developing my idea. Tip-up assemblies that move and have more function results in not only catching more fish, it also keeps lines from freezing into the ice because of greater movement. Claimed tip-ups are simplified by pulling out or putting in band in support structure on claimed tip-ups. Prior wind tip-ups that were folded or collapsed was a problem due to icing on prior tip-up structures being folded or collapsed, for transportation and storing. Also prior tip-ups take up more space. Claimed tip-up construction allows greater movement and function, due to claimed tip-up band construction versus wood construction.

### SUMMARY OF INVENTION

The primary object of the present invention ice-fishing apparatus is to be compatible with ice-fishing conditions. is a further object of the invention to become a simplified disassemble and assemble for transport and storage, and preventative freezing on structure of apparatus.

It's further object is a greater moving function.

It's further object is claimed tip-up can be adjusted for smaller fish.

It's further object is to move in low wind conditions.

It's further object is to take up less space than other wind tip-ups for transport and storage.

It's further object is to allow assembly and disassembly with no ice on structure of tip-ups due to a different construction, a non-folding or non-collapsing claimed tip-up.

### SUMMARY

Prior wind tip-ups are constructed differently. Their moving function is limited. Claimed tip-up construction allows greater moving function due to a flexible, thin steel band construction versus a wood construction. Claimed tip-up has adjusting weights, which can be adjusted for smaller fish.

By adjusting weights on wire flag, by sliding one weight forward on wire flag towards ice-fishing hole, also weights aid in tipping up flag.

### BRIEF DESCRIPTION OF THE DRAWINGS

FIG. 1 shows an assembled perspective drawing of the invention as it appears in normal use relative to an ice hole.

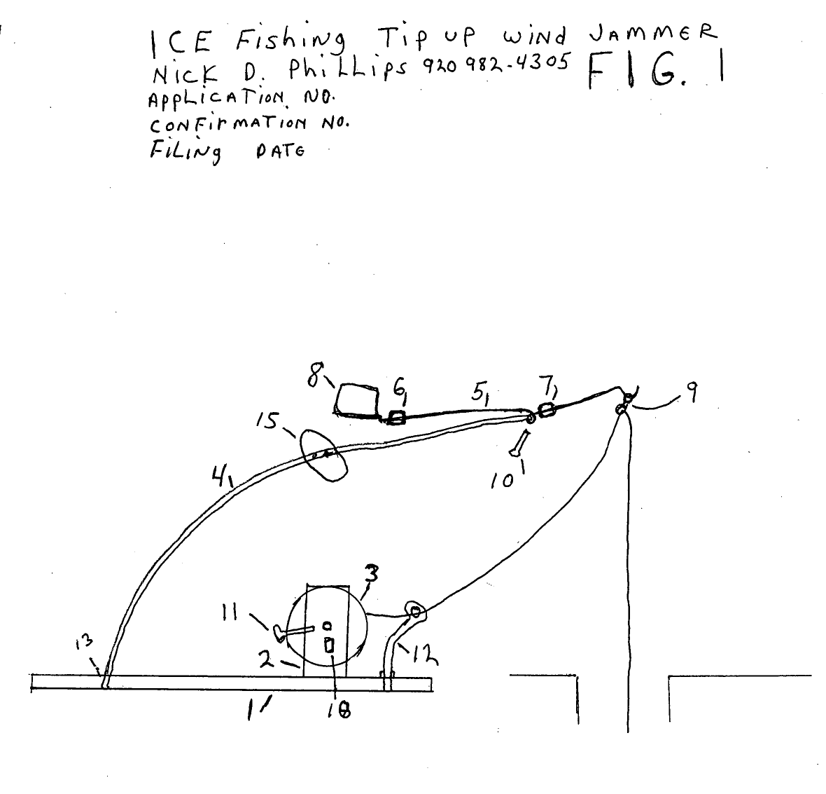

FIG. 2 shows an assembled perspective drawing of the invention when it is triggered or set off by fish bite.

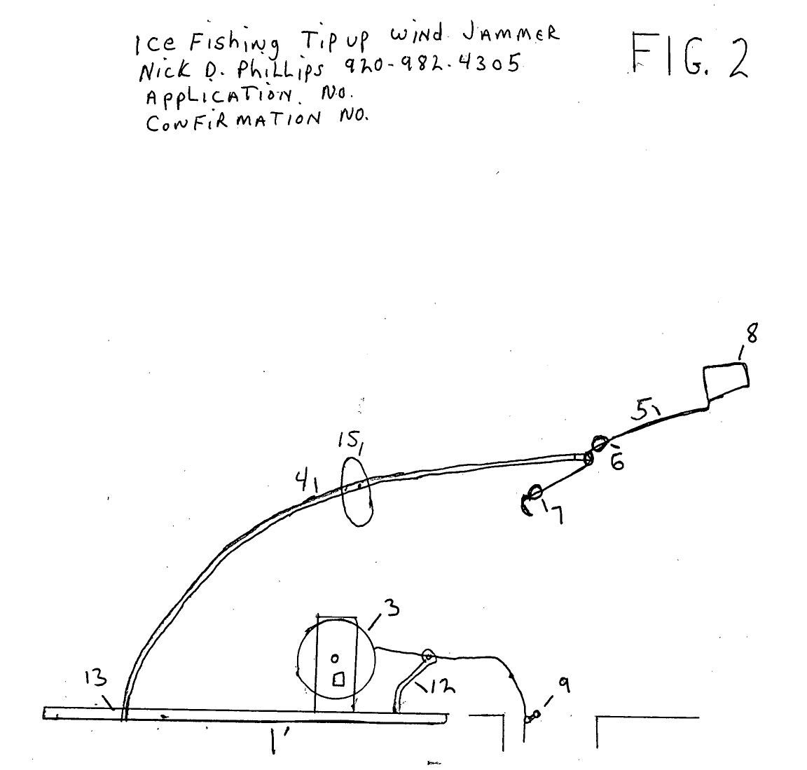

FIG. 3 is an elevation drawing showing invention in an unassembled view.

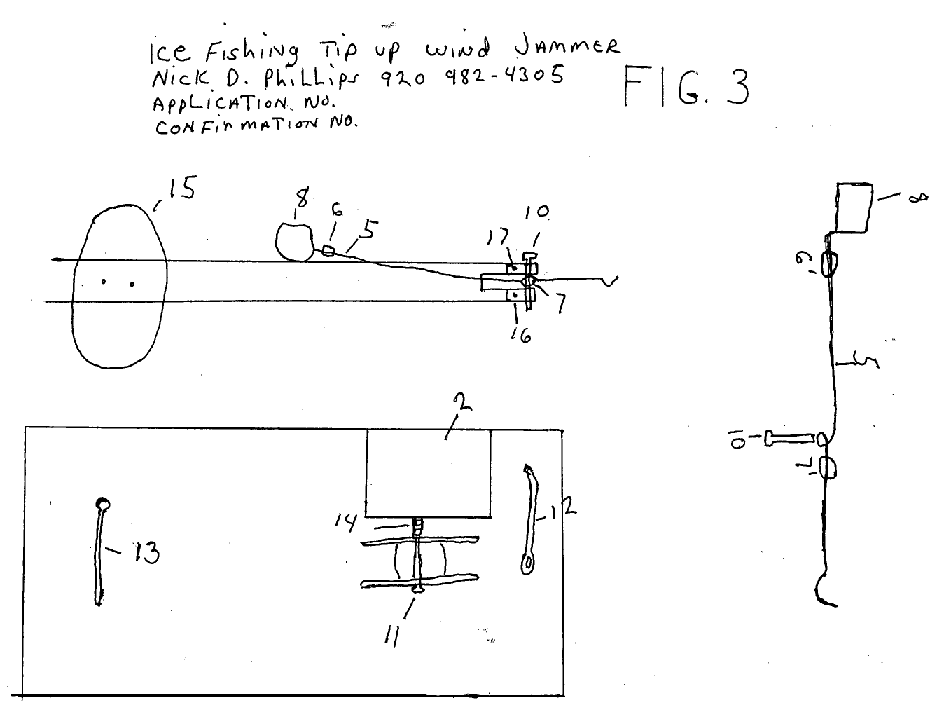

### DETAILED DESCRIPTION OF INVENTION

My claimed invention is a wind-driven ice-fishing tip-up. It is a bait-moving tip-up, which jigs in an up and down motion, jigging the bait, to attract fish Wind makes flexible band move and attached plastic wind device aids in moving device, this being attached to steel band. To make claimed invention, first there is a claimed support structure, made of wood. In this claimed support structure is a saw-cut groove in the flat wood base, in which flexible band is inserted in saw-cut groove. On claimed tip-up is an upright claimed piece of wood, attached to support structure. A claimed line spool with a claimed stationary pin goes into said upright piece of wood, thus holding spool on. Claimed steel band of tip-up has a wire flag attached to end of steel band, with a pin going through wire flag assembly consisting of two weights, and one cloth flag. Wire flag is then bent in middle of wire flag, completely around, leaving a loop. Next bend is end of wire flag, a slight bend for line to be placed on. Next is a slight bend in front of cloth flag. Then cloth flag is attached. This claimed wire flag is then attached to claimed steel band. Claimed steel band is cut at end, cutting small one-quarter-inch piece out. Next claimed pin is put through claimed wire flag. Next said end of steel band is bent around pin and riveted, holding wire flag on. Claimed tip-up works by a fish pulling on line. Wire flag is pulled forward. Weights move forward, and wire flag tips up. As claimed wire flag tips up, line falls two feet to ice hole. Fish can then move line spool.

1. An ice-fishing tip-up comprising
A. Support structure for supporting said tip-up on a surface of ice through which a user wishes to fish
B. An upright mounted to said support structure said upright being mounted onto base support structure
C. A flexible moving steel band mounted in said tip-up support structure into cut slot in base of wood support structure with plastic wind device attached to steel band enabling wind to move steel band and attached pin holding wire flag device and weights on wire of flag
D. A spool mounted on upright attached with a stationary pin to support structure and said flexible steel band into support structure
E. A spring on said stationary pin between spool and upright mounted to said upright spring on pin between upright and spool
F. An eyelet mounted to said support structure with said threaded line with barrel swivel through eyelet used as a line guide

2. An ice-fishing tip-up as in claim 1. Said spool being mounted for free spool rotation on said upright rotating on said pin with said spring resting against spool and upright

3. An ice-fishing tip-up as in claim 1. Rotating spool attached to support structure with said cut slot in support structure which said flexible steel band with attached plastic wind moving motion device and said attached wire flag

4. An ice-fishing tip-up as in claim 3.Said attached wire flag which consists of two weights which slide back and forth on wire flag signaling device

5. An ice-fishing tip-up as in claim 4.Said attached wire flag has bend on end of wire flag signaling device for said barrel swivel to be hooked on end of wire flag a barrel swivel being tied to fishing line

6. An ice-fishing tip-up as in claim 5.Said attached wire flag has a bend for cloth flag attachment

7. An ice-fishing tip-up as in claim 6. Said wire flag is attached to said flexible steel band with said attaching pin with end of steel band with a cut slot which steel is bent around said flag attachment pin.Attaching wire flag to flexible steel band wrapping steel around attaching pin is then riveted in place

8. An ice-fishing tip-up as in claim 1. Said tip-up said line is pulled, tripping said flag sending said flag weights forward tripping said barrel swivel tied to line thus falls drops two feet to ice hole. Fish then tightens line thus rotating spool with spring assembly
